(19) United States
(12) Patent Application Publication
(10) Pub. No.: US 2021/0226520 A1
(43) Pub. Date: Jul. 22, 2021

(54) Magnet Actuator for an Electronic Device and Electronic Device Comprising said Magnet Actuator

(71) Applicant: Huawei Technologies Co., Ltd., Shenzhen (CN)

(72) Inventor: Ossi Maenpaa, Helsinki (FI)

(21) Appl. No.: 15/734,017

(22) PCT Filed: Jun. 11, 2018
(86) PCT No.: PCT/EP2018/065341

§ 371 Date: Dec. 1, 2020

(51) Int. Cl. H02K 33/18; B06B 1/04

(52) U.S. Cl. CPC H02K 33/18; B06B 1/045

(57) ABSTRACT

A magnet actuator (1) for use in an electronic device, comprising a first magnet arrangement (2), a second magnet arrangement (3), comprising a first magnet (3a) and a second magnet (3b), and a coil (4) arranged between the first magnet arrangement (2) and the second magnet arrangement (3). The first magnet arrangement (2) and the second magnet arrangement (3) are arranged so that magnetic fields, generated by the first magnet arrangement (2) and the second magnet arrangement (3), causes an attractive force (F1) and a repulsive force (F2) between the first magnet arrangement (2) and the second magnet arrangement (3), which maintain the first magnet arrangement (2) and the second magnet arrangement (3) in a force equilibrium state.

### TECHNICAL FIELD

The disclosure relates to a magnet actuator for use in an electronic device, the magnet actuator comprising a first magnet arrangement, a second magnet arrangement, and a coil arranged between the first magnet arrangement and the second magnet arrangement.

### BACKGROUND

Electronic devices may be provided with magnet actuators in order to generate, e.g., sound waves. A magnet actuator comprises magnets which either attract or repulse each other. Initially, the magnets are arranged in force equilibrium, but in order to generate sound waves the attractive or repulsive force between the magnets is changed by means of an electric current passing through a coil located between the magnets, the current causing at least one of the magnets to move such that the distance between the magnets decreases or increases.

As disclosed in GB2532436, the magnets may be interconnected by means of resilient support elements which counteract the attractive or repulsive force between the magnets such that the magnets and the resilient support element are in a force equilibrium state as long as no current is supplied. The different components of the magnet actuator of GB2532436 are integrated into the device structure and arranged between the main elements of the device. The appearance of the assembled electronic device can be assessed only after the force equilibrium state has been reached, i.e. after the main elements of the device have been assembled. Any possible defects, caused by dimensional tolerance variations of each separate element in the structure, variations in force between the magnets, or variations in the force caused by the resilient support element, will be visible only after assembly, and will subsequently be time consuming and costly to repair.

### SUMMARY

It is an object to provide an improved magnet actuator. The foregoing and other objects are achieved by the features of the independent claims. Further implementation forms are apparent from the dependent claims, the description, and the figures.

The present invention is defined by the appended independent claims.

According to a first aspect, there is provided a magnet actuator for use in an electronic device, comprising a first magnet arrangement, a second magnet arrangement, comprising a first magnet and a second magnet, and a coil arranged between the first magnet arrangement and the second magnet arrangement, the coil comprising a plurality of coil windings,

the first magnet arrangement and the second magnet arrangement being arranged so that magnetic fields, generated by the first magnet arrangement and the second magnet arrangement, causes an attractive force and a repulsive force between the first magnet arrangement and the second magnet arrangement, maintaining the first magnet arrangement and the second magnet arrangement in a force equilibrium state, the coil windings extending in a first direction when the coil is arranged between the first magnet arrangement and the first magnet of the second magnet arrangement, and extending in an opposite, second direction when the coil is arranged between the first magnet arrangement and the second magnet of the second magnet arrangement.

A magnet actuator such as this, wherein the magnets are in a force equilibrium state, facilitates the manufacture of the electronic device in which the magnet actuator is placed. The forces caused by the magnets are balanced from the start, such that the other components of the electronic device remain unaffected by, e.g., variations in the force of the magnets or dimensional variation of the different components of the magnet actuator. Such a solution reduces the number of defective electronic devices and hence manufacturing and repair costs.

In a possible implementation form of the first aspect, manipulating the electrical current in the coil causes a change in the attractive force and the repulsive force thereby causing a displacement between the first magnet arrangement and the second magnet arrangement, facilitating a sufficiently strong yet spatially efficient actuator.

In a further possible implementation form of the first aspect, the first magnet and the second magnet of the second magnet arrangement are arranged so that magnetic fields cause a repulsive force between the first magnet arrangement and the first magnet of the second magnet arrangement, and an attractive force between the first magnet arrangement and the second magnet of the second magnet arrangement, or so that magnetic fields cause an attractive force between the first magnet arrangement and the first magnet of the second magnet arrangement, and a repulsive force between the first magnet arrangement and the second magnet of the second magnet arrangement, a solution by which magnets of opposing forces can be arranged adjacent each other in a space efficient way.

In a further possible implementation form of the first aspect, the coil is a planar coil, the peripheral dimensions of each coil winding decreasing in a direction from a periphery of the second magnet arrangement towards a center of the second magnet arrangement, such a coil being a highly space efficient component.

In a further possible implementation form of the first aspect, the coil windings extend in a plane perpendicular to the directions of the attractive and repulsive forces caused by the magnetic fields, allowing the size of the attractive force and the repulsive force to be of the same magnitude such that the first magnet arrangement and the second magnet arrangement are separated by an even air gap at all times.

In a further possible implementation form of the first aspect, the first magnet of the second magnet arrangement is arranged such that it at least partially surrounds the second magnet of the second magnet arrangement, facilitating an even distribution of attractive and repulsive forces.

In a further possible implementation form of the first aspect, the first magnet of the second magnet arrangement is solid, and the second magnet of the second magnet arrangement comprises a cavity adapted for accommodating the first magnet, providing a space efficient magnet arrangement.

In a further possible implementation form of the first aspect, the first magnet and the second magnet of the second magnet arrangement have at least one of identical surface area and identical volume, such that the attractive and repulsive forces generated by the magnets have the same size.

In a further possible implementation form of the first aspect, the second magnet of the second magnet arrangement comprises at least two interconnected magnet parts, facilitating the assembly of the magnet actuator.

In a further possible implementation form of the first aspect, an outer periphery of the first magnet, an inner periphery of the second magnet, and an outer periphery of the second magnet are circular, facilitating a magnet actuator which is as small as possible while able to provide maximum attractive and repulsive forces.

In a further possible implementation form of the first aspect, the magnet further comprises a first housing and a second housing, the first magnet arrangement being at least partially located within the first housing, and the second magnet arrangement being at least partially located within the second housing, allowing the magnet actuator to be configured as one integral component which is easily mounted in an electronic device.

In a further possible implementation form of the first aspect, the first housing and the second housing limit the magnetic fields to an enclosed space within at least one of the first housing and the second housing, preventing the magnetic fields from interfering with other objects.

In a further possible implementation form of the first aspect, the second housing comprises a first housing part and a second housing part, the first magnet of the second magnet arrangement being located within the first housing part of the second housing, and the second magnet of the second magnet arrangement being located within the second housing part of the second housing, preventing the first magnet and the second magnet from interfering with each other and allowing the second magnet arrangement to be assembled in parts.

In a further possible implementation form of the first aspect, the first housing and the second housing have an open end and a closed base connected by a surrounding wall, an inner periphery of the first housing substantially corresponding to an outer periphery of the second housing, with allowance for movement between the first housing and the second housing, which is a simple yet reliable construction which provides sufficient protection for the magnet arrangement as well as efficiently limits the magnetic fields to the cavity formed by the first housing and the second housing.

In a further possible implementation form of the first aspect, the first housing and the second housing are partially overlapping, allowing the magnet actuator to be assembled into, and maintained as, one integral part.

According to a second aspect, there is provided an electronic device comprising a movable surface, a device chassis, and

a magnet actuator arranged between the movable surface and the device chassis, and adapted to move the movable surface relative to the device chassis.

By providing an electronic device with a magnet actuator which is balanced from the start, the other components of the electronic device remain unaffected by, e.g., variations in the force of the magnets or dimensional variation of the different components of the magnet actuator. Such a solution reduces the number of defective electronic devices and hence manufacturing and repair costs.

In a possible implementation form of the second aspect, a first housing of the magnet actuator is attached to the movable surface, and a second housing of the magnet actuator is attached to the device chassis, or the second housing of the magnet actuator is attached to the movable surface and the first housing of the magnet actuator is attached to the device chassis, facilitating a very stable magnet actuator which can withstand large external forces.

In a further possible implementation form of the second aspect, movement of the movable surface generates vibrations within the electronic device to be used as haptic means or for generating sound waves.

This and other aspects will be apparent from and the embodiment(s) described below.

### BRIEF DESCRIPTION OF THE DRAWINGS

In the following detailed portion of the present disclosure, the aspects, embodiments, and implementations will be explained in more detail with reference to the example embodiments shown in the drawings, in which:

FIG. 1 shows an exploded view of a magnet actuator in accordance with one embodiment of the present invention;

FIG. 2 shows a partial, cross-sectional side view of the magnet actuator shown in FIG. 1;

FIG. 3 shows a cross-sectional side view of an electronic device comprising the magnetic actuator shown in FIGS. 1 and 2;

FIG. 4 shows a top view of a coil and second magnet arrangement comprised in the magnet actuator shown in FIGS. 1 to 3;

FIG. 5 shows a perspective side view of the coil and second magnet arrangement shown in FIG. 4;

FIG. 6 shows a cross-sectional side view of the magnet actuator shown in FIGS. 1 to 5;

FIG. 7 shows a cross-sectional side view of a magnet actuator in accordance with another embodiment of the present invention.

### DETAILED DESCRIPTION

Conventional magnet actuators are subject to a range of possible defects. After the forces within the magnet actuator, generated by the magnets and other possible components such as resilient elements arranged between the magnets, have been balanced, the final position of the vibration transmitting part of the magnet actuator may be located at a position which is either too far away from or too close to the stationary part of the magnet actuator, i.e. the part which is attached to, e.g., the chassis of an electronic device. The reason for these deviations may be variation in the force of the resilient element, variation in the force of the magnets, or dimensional variations in the different components of the magnet actuator. This causes the electronic device to be rejected at quality control due to lacking visual quality. Defects may also be the result of the movable part of the electronic device, i.e. the part connected to the vibration transmitting part of the magnet actuator, having insufficient stiffness, such that the forces applied by the magnets and the counterforce applied by the resilient element causes the movable part to bend outwards from or inwards towards the stationary part. Furthermore, one of the magnets may, with time, detach from the electronic device due to the constant pulling force acting on the magnet.

The above-mentioned disadvantages are overcome by means of the embodiments of the present disclosure.

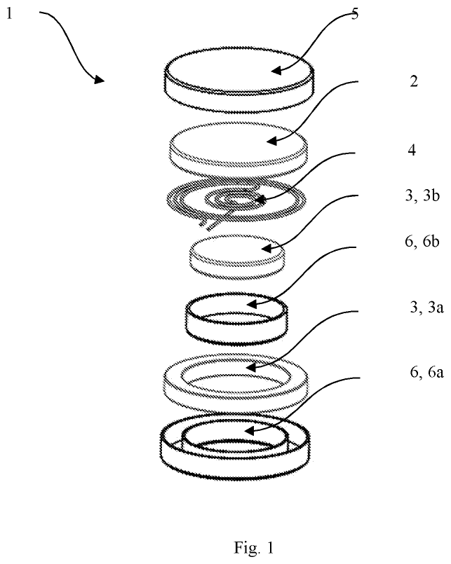

FIG. 1 shows an embodiment of the magnet actuator 1 in accordance with the present disclosure.

The magnet actuator 1 comprises a first magnet arrangement 2 and a second magnet arrangement 3. The second magnet arrangement 3 comprises a first magnet 3a and a second magnet 3b.

The first magnet arrangement 2 and the second magnet arrangement 3 are arranged so that magnetic fields, generated by the first magnet arrangement 2 and the second magnet arrangement 3, cause an attractive force F1 as well as a repulsive force F2 between the first magnet arrangement 2 and the second magnet arrangement 3. As a result thereof, the first magnet arrangement 2 and the second magnet arrangement 3 are maintained in a force equilibrium state.

In one embodiment, the first magnet 3a of the second magnet arrangement is arranged such that it at least partially surrounds the second magnet 3b of the second magnet arrangement.

The magnet of the first magnet arrangement 2 may be solid and circular, essentially forming a solid cylinder or disc.

The second magnet 3b of the second magnet arrangement may be solid, while the first magnet 3a of the second magnet arrangement comprises a corresponding cavity adapted for accommodating the second magnet 3b.

The outer periphery as well as the inner periphery of the first magnet 3a may be circular such that the first magnet 3a has a ring or open cylinder shape. The outer periphery of the second magnet 3b may also be circular (e.g. forming a cylinder or disc), in order to be form-fitted with the cavity of first magnet 3a.

The magnets of the first magnet arrangement 2 and the second magnet 3b are preferably solid magnets, while the first magnet 3a is hollow. The magnets may all have a circular shape, as well as an oval, rectangular, or hexagonal shape.

In a further embodiment, the first magnet 3a of the second magnet 3 arrangement comprises at least two interconnected magnet parts. The two interconnected magnet parts may comprise of two identical halves, such as e.g. two ring halves or two cylinder halves. Of course, the first magnet 3a may comprise of more than two magnet parts, and the magnet parts need not be identical.

In one embodiment, the first magnet 3a and the second magnet 3b of the second magnet arrangement 3 are arranged so that the magnetic fields cause a repulsive force F2 between the first magnet arrangement 2 and the first magnet 3a of the second magnet arrangement, and an attractive force F1 between the first magnet arrangement 2 and the second magnet 3b of the second magnet arrangement.

In another embodiment, the first magnet 3a and the second magnet 3b of the second magnet arrangement 3 are arranged so that the magnetic fields cause an attractive force F1 between the first magnet arrangement 2 and the first magnet 3a of the second magnet arrangement, and a repulsive force F2 between the first magnet arrangement 2 and the second magnet 3b of the second magnet arrangement.

The first magnet 3a and the second magnet 3b of the second magnet arrangement preferably have either an identical surface area or an identical volume, or both.

The magnet actuator is connected to electrical means which transfer electrical current to the coil 4.

A coil 4 is arranged between the first magnet arrangement 2 and the second magnet arrangement 3. The coil 4 comprises a plurality of coil windings 4a. In an embodiment of the present invention the coil 4 comprises in the area of 100-200 of such coil windings 4a. The Figs. have been simplified for the sake of clarity, and only show a few of said coil windings 4a.

The coil 4 is preferably a planar coil, however, any suitable coil may be used. The peripheral dimensions of each coil winding 4a of the planar coil decreases in the direction from the periphery of the second magnet arrangement 3 towards the center of the second magnet arrangement 3.

The coil windings 4a extend in a first direction D1 when the coil 4 is arranged between the first magnet arrangement 2 and the first magnet 3a of the second magnet arrangement. The coil windings 4a extend in an opposite, second direction D2 when the coil 4 is arranged between the first magnet arrangement 2 and the second magnet 3b of the second magnet arrangement.

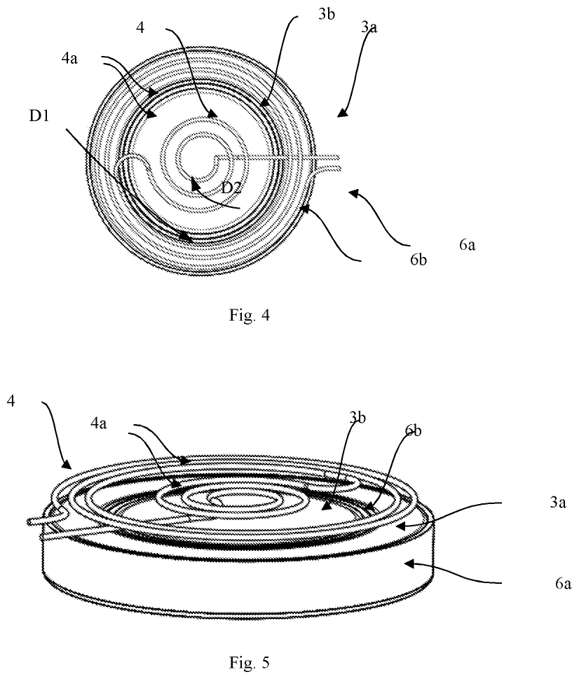

As shown in the embodiment of FIGS. 4 and 5, the coil windings 4a extend in a first, counterclockwise direction D1 when arranged between the first magnet arrangement 2 and the first magnet 3a of the second magnet arrangement, and the coil windings 4a extend in a second, clockwise direction D2 when arranged between the first magnet arrangement 2 and the second magnet 3b of the second magnet arrangement. The coils windings 4a extend in a plane perpendicular to the directions of the attractive F1 and repulsive F2 forces caused by the magnetic fields.

Manipulating the electrical current in the coil 4 causes a change in the attractive force F1 and the repulsive force F2 thereby causing a displacement between the first magnet arrangement 2 and the second magnet arrangement 3.

In one embodiment, the magnet actuator 1 comprises a first housing 5 and a second housing 6, the first magnet arrangement 2 being at least partially located within the first housing 5, and the second magnet arrangement 3 being at least partially located within the second housing 6.

The first housing 5 and the second housing 6 limit the magnetic fields to an enclosed space such that the first housing 5, the second housing 6, or both, prevent the magnetic fields from interfering with other objects such as the other components of the electronic device. The first housing 5 and the second housing 6 are at least partly made of a magnetic material.

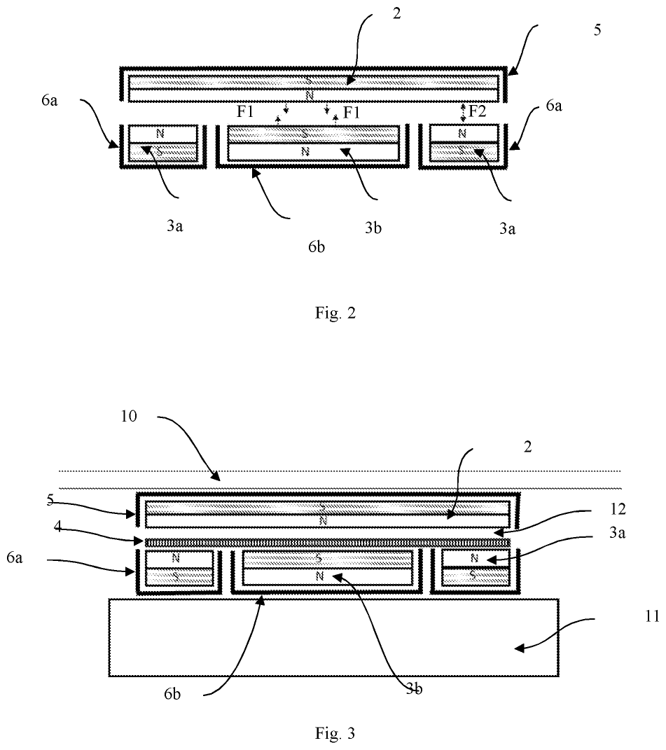

As shown in FIGS. 2 and 3, the second housing 6 may comprise a first housing part 6a and a second housing part 6b, the first magnet 3a of the second magnet arrangement being located within the first housing part 6a of the second housing, and the second magnet 3b of the second magnet arrangement being located within the second housing part 6b of the second housing. This prevents the first magnet 3a and the second magnet 3b from interfering with each other.

The first housing 5 and the second housing 6 may both be configured such that they have an open end 7 and a closed base 8 connected by at least one surrounding wall 9, e.g. being shaped as a cylinder having one sealed off end and one open end. The closed base 8 of the first housing 5 is connected to, or arranged directly in abutment with, the movable, vibration transmitting surface 10 of the electronic device. Hence, the movable surface 10 is moved along with the first magnet arrangement 2, which generates vibrations within the electronic device, e.g. causing sound waves. The second magnet arrangement 3 is connected to the closed base 10 of the second housing 6, which in turn is connected to the device chassis 11.

The first housing 5 is essentially shaped to accommodate the magnet of the first magnet arrangement 2. Hence, if the magnet is shaped as a solid cylinder, as shown in FIG. 1, the first housing 5 is shaped as a hollow cylinder.

The second housing 6 is essentially shaped to accommodate the first magnet 3a and the second magnet 3b of the second magnet arrangement 3. The second housing 6 may comprise of one integral housing, having an internal wall separating the first magnet 3a from the second magnet 3b, as shown in FIG. 7. The second housing 6 may also comprise of a first housing part 6a, accommodating the first magnet 3a and surrounding a second housing part 6b, as shown in FIG. 1. The first housing part 6a is, in this embodiment, shaped as a hollow cylinder, and the second housing part 6b is shaped as a cylinder having one sealed off end and one open end. The second housing part 6b is shaped to fit into the cavity of hollow first housing part 6a.

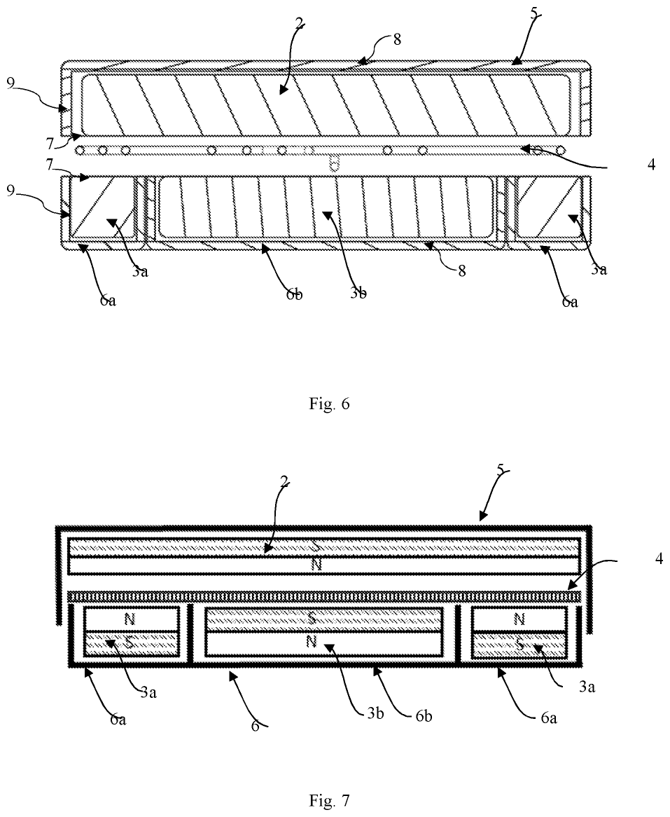

The outer periphery of the first housing 5 may substantially correspond to the outer periphery of the second housing 6, such that the first housing 5 and the second housing 6 have the same dimensions for the surrounding walls 9, see FIG. 6.

The inner periphery of the first housing 5 may instead correspond substantially to the outer periphery of the second housing 6, with allowance for movement between the first housing 5 and the second housing 6, such that the surrounding wall 9 of the first housing 5 can at least partially overlap the surrounding wall 9 of the second housing 6, see FIG. 7.

FIG. 3 shows an embodiment of an electronic device comprising the above described magnet actuator 1 in accordance with the present disclosure. The electronic device may be a smart phone, a tablet, or any other electronic device needing to facilitate vibrations.

The electronic device comprises a movable surface 10, such as a display, a device chassis 11, the magnet actuator 1 arranged between the movable surface 10 and the device chassis 11. The movable surface 10/display may be of glass and attached to the device chassis 11 by means of an elastic adhesive. Furthermore, the movable surface 10/display may itself be elastic.

The magnet actuator 1 is adapted to move the movable surface 10 relative to the device chassis 11. When manipulating the electrical current in the coil 4 a change in the attractive F1 or repulsive F2 force is caused, which in turn causes a displacement between the first magnet arrangement 2 and the second magnet arrangement 3, i.e. causing the first magnet arrangement 2 to move in relation to the second magnet arrangement 3. Subsequently, this displacement causes the movable surface 10 of the electronic device to move in relation to the device chassis 11. The movement of the movable surface 10 generates vibrations within the electronic device, the vibrations being used for generating sound waves or as a haptic means providing tactile feedback to the user.

In one embodiment, the first housing 5 of the magnet actuator 1 is attached to the movable surface 10, and a second housing 6 of the magnet actuator 1 is attached to the device chassis 11. In a further embodiment, the second housing 6 of the magnet actuator 1 is attached to the movable surface 10 and the first housing 5 of the magnet actuator 1 is attached to the device chassis 11.

The various aspects and implementations has been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

The reference signs used in the claims shall not be construed as limiting the scope.

1-17. (canceled)

18. A magnet actuator comprising:
a first magnet arrangement;
a second magnet arrangement comprising a first magnet and a second magnet, wherein the first magnet arrangement and the second magnet arrangement are arranged such that a plurality of magnetic fields from the first magnet arrangement and the second magnet arrangement cause an attractive force and a repulsive force between the first magnet arrangement and the second magnet arrangement to maintain the first magnet arrangement and the second magnet arrangement in a force equilibrium state; and
a coil arranged between the first magnet arrangement and the second magnet arrangement and comprising a plurality of coil windings,
wherein the coil windings are configured to extend in a first direction when the coil is between the first magnet arrangement and the first magnet, and
wherein the coil windings are configured to extend in a second direction opposite to the first direction when the coil is between the first magnet arrangement and the second magnet.

19. The magnet actuator of claim 18, wherein a change in the attractive force and the repulsive force is based on a manipulation of electrical current in the coil, wherein the change causes a displacement between the first magnet arrangement and the second magnet arrangement.

20. The magnet actuator of claim 18, wherein the first magnet and the second magnet are arranged such that the magnetic fields cause the repulsive force between the first magnet arrangement and the first magnet and the attractive force between the first magnet arrangement and the second magnet.

21. The magnet actuator of claim 18, wherein the coil windings extend in a plane perpendicular to the directions of the attractive force and the repulsive force.

22. The magnet actuator of claim 18, wherein the first magnet is arranged such that the first magnet partially surrounds the second magnet.

23. The magnet actuator of claim 22, wherein the second magnet is solid, and wherein the first magnet comprises a cavity to accommodate the second magnet.

24. The magnet actuator of claim 18, wherein the first magnet and the second magnet have at least one of an identical surface area or an identical volume.

25. The magnet actuator of claim 18, wherein the first magnet comprises at least two interconnected magnet parts.

26. The magnet actuator of claim 18, wherein the second magnet comprises an outer periphery that is circular, and wherein the first magnet comprises an inner periphery and an outer periphery that are circular.

27. The magnet actuator of claim 18, further comprising:
a first housing coupled to the first magnet arrangement; and
a second housing coupled to the second magnet arrangement.

28. The magnet actuator of claim 27, wherein the first housing and the second housing are configured to limit the magnetic fields to an enclosed space within at least one of the first housing or the second housing.

29. The magnet actuator of claim 27, wherein the second housing comprises:
a first housing part coupled to the first magnet; and
a second housing part coupled to the second magnet.

30. The magnet actuator of claim 27, wherein the first housing and the second housing each have an open end and a closed base connected by a surrounding wall, wherein the first housing comprises an inner periphery, wherein the second housing comprises an outer periphery, wherein the inner periphery corresponds to the outer periphery, and wherein the first housing moves relative to the second housing.

31. The magnet actuator of claim 27, wherein the first housing and the second housing overlap.

32. The magnet actuator of claim 18, wherein the first magnet and the second magnet are arranged such that the magnetic fields cause the attractive force between the first magnet arrangement and the first magnet and the repulsive force between the first magnet arrangement and the second magnet.

33. The magnet actuator of claim 18, wherein the first magnet and the second magnet are arranged such that the magnetic fields cause the repulsive force between the first magnet arrangement and the first magnet and the attractive force between the first magnet arrangement and the second magnet.

34. An electronic device comprising:
a movable surface;
a device chassis coupled to the movable surface; and
a magnet actuator arranged between the movable surface and the device chassis, and configured to move the movable surface relative to the device chassis, wherein the magnet actuator comprises:
a first magnet arrangement;
a second magnet arrangement comprising a first magnet and a second magnet, wherein the first magnet arrangement and the second magnet arrangement are arranged such that a plurality of magnetic fields from the first magnet arrangement and the second magnet arrangement cause an attractive force and a repulsive force between the first magnet arrangement and the second magnet arrangement to maintain the first magnet arrangement and the second magnet arrangement in a force equilibrium state; and
a coil arranged between the first magnet arrangement and the second magnet arrangement and comprising a plurality of coil windings, wherein the coil windings are configured to extend in a first direction when the coil is between the first magnet arrangement and the first magnet, and wherein the coil windings are configured to extend in a second direction opposite the first direction when the coil is between the first magnet arrangement and the second magnet.

35. The electronic device of claim 34, wherein the magnet actuator further comprises:
a first housing attached to the movable surface; and
a second housing attached to the device chassis.

36. The electronic device of claim 34, wherein movement of the movable surface generates vibrations within the electronic device.

37. A device for facilitation vibrations comprising:
a first magnet arrangement;
a second magnet arrangement comprising a first magnet and a second magnet, wherein the first magnet arrangement and the second magnet arrangement are arranged such that a plurality of magnetic fields from the first magnet arrangement and the second magnet arrangement cause an attractive force and a repulsive force between the first magnet arrangement and the second magnet arrangement to maintain the first magnet arrangement and the second magnet arrangement in a force equilibrium state;
a coil arranged between the first magnet arrangement and the second magnet arrangement and comprising a plurality of coil windings, wherein the coil windings are configured to extend in a first direction when the coil is between the first magnet arrangement and the first magnet, and wherein the coil windings are configured to extend in a second direction opposite the first direction when the coil is between the first magnet arrangement and the second magnet;
a first housing coupled to the first magnet arrangement; and
a second housing coupled to the second magnet arrangement, wherein the first housing and the second housing are configured to limit the magnetic fields to an enclosed space within at least one of the first housing or the second housing.
